(19) United States
(12) Patent Application Publication
(10) Pub. No.: US 2022/0384999 A1
(43) Pub. Date: Dec. 1, 2022

(54) SHIELDED ELECTRICAL CONNECTOR

(71) Applicant: Panduit Corp., Tinley Park, IL (US)

(72) Inventors: David J. Papesh, Joliet, IL (US); Satish I. Patel, Roselle, IL (US)

(73) Assignee: Panduit Corp., Tinley Park, IL (US)

(21) Appl. No.: 17/330,740

(22) Filed: May 26, 2021

(51) Int. Cl. H01R 13/6591; H01R 13/6583; H01R 24/86; H01R 13/6592

(52) U.S. Cl. CPC H01R 13/65915; H01R 13/6583; H01R 13/65917; H01R 24/86; H01R 13/6592

(57) ABSTRACT

An industrial connector has a cylindrical metal shield with at least one slot in the rear of the shield for engaging a cable braid. In one embodiment, the shield also has a cable relief cut out of the rear opposite the at least one slot.

### FIELD OF THE INVENTION

The present invention relates generally to industrial connectors and more specifically to a technique to aid in connecting a metal braid of a cable to a shield of the industrial connector.

### BACKGROUND

Many automated processes depend on molded cable assemblies in industry. A variety of harsh environments are possible in many of these applications, requiring them to withstand a multitude of durability and weather resistance tests. Creating a cord set with a unique boot, while also meeting typical industry speeds and standards, allows for companies to enter this market and gives them an opportunity to compete in this industry. Some of these standards include IP67 for withstanding dust, dirt, sand and water, as well as NEMA 3, 4 and 6 for outdoor use.

Overmolded connectors come in different shapes and forms. A 90-degree connector is the most challenging due to the tight space and aggressive 90-degree bend for the cable or wires. Existing art depicts the use metal shields to manage the cable to for the 90° bend. This adds cost and complication to the designs.

Other variants utilize a shielded cable that has a metal braided sleeve that is bonded to the metal shield of the connector. The bonding is completed by either crimping the braid to the metal shield, soldering the braid to the metal shield, or performing both operations. The crimping and soldering also adds cost and assembly time to the assembly.

### SUMMARY

An industrial connector has a cylindrical metal shield with at least one slot in the rear of the shield for engaging a cable braid. In one embodiment, the shield also has a cable relief cut out of the rear opposite the at least one slot.

### BRIEF DESCRIPTION OF THE DRAWINGS

FIG. 1 shows isometric views of a male connector with an improved technique for electrically connecting a cable braid to the shield of the connector.

FIG. 2 shows a female connector with an improved technique for electrically connecting a cable braid to the shield of the connector.

FIG. 3 shows top, side, and back views of the connector of FIG. 1 with a cable attached.

FIG. 4 shows top, side, and front views of the connector of FIG. 3 after connector has completed the overmolding process.

### DESCRIPTION OF THE INVENTION

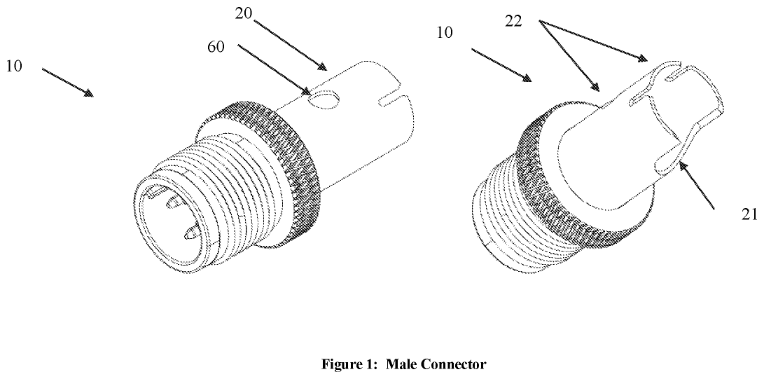

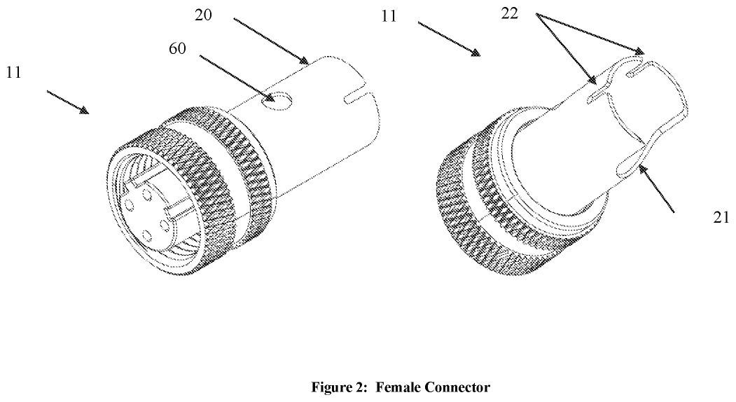

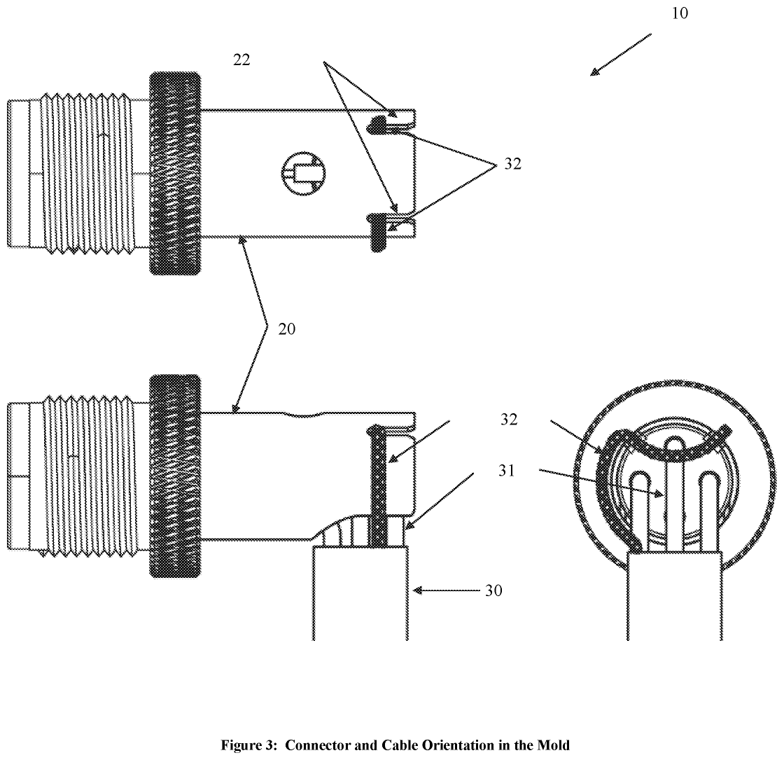

FIGS. 1 and 2 show exemplary male 10 and female 11 connectors, respectively, of the present invention. After soldering, the connector is overmolded with a thermoplastic elastomer. Both the male and female connectors have a cylindrical metal shield 20. This invention outlines the method for retaining the industrial cable shielding braid 32 (see FIG. 3) on the connector's metal shield 20. This creates a bonded electrical ground for an industrial patch cord. The overmolding process assists in retaining the braid onto the connector shield.

The connector shield 20 is longer in length compared to prior art. The additional length allows for the overmold to adhere to more surface area of the connector creating a greater seal for withstanding water submersion. The rear of the connector shield has a cable relief 21 to allow the cable to be routed through 90° to the connector axis. Two slots 22 are also cut on the top of the connector shield to route the cable braid through. The cable relief 21 and slots 22 are shown in FIGS. 1 and FIG. 2. This is similar to an insulation displacement conductor (IDC). As shown in FIG. 3. The cable 30 is stripped and the cable conductors 31 are soldered to the electrical conductors of the connector (conductors are not shown in FIG. 3, but see conductors 50 of FIG. 1 for reference). The cable braid 32 is twisted separate from the cable conductors. The cable braid is routed along the circumference of the shield 20, through a first slot 22 and looped back through the slot 22 on the opposite side. The slots 22 retain the cable braid 32 during molding. During the connector overmolding process, the molding material flows around the outside of the connector and through the hole 60 in the top of the connector. The material flowing in the hole 60 fills the inside of the connector shield 20. The pressure from the molding process compresses the cable braid 32 against the outside of the connector shield 20 and the inside of the cable shield 20. The compression of the braid against the shield completes the cable braid bonding to the connector shield.

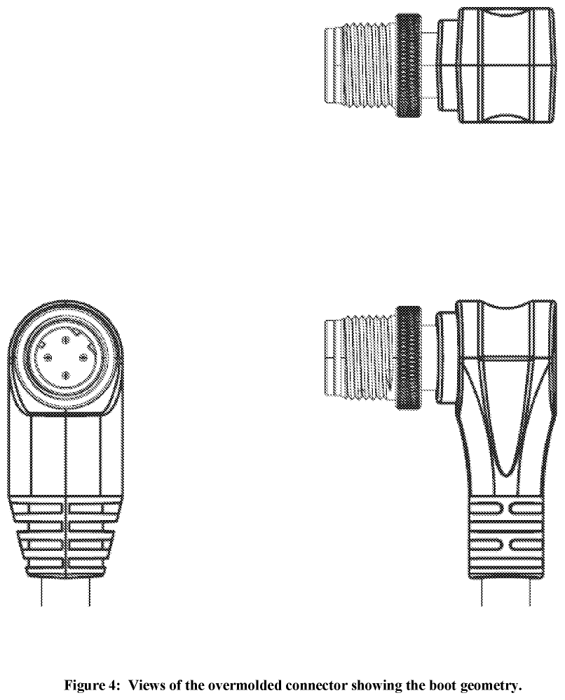

After soldering, the connector is overmolded with a thermoplastic elastomer. The overmolding creates a boot that protects the connector from the environment. The boot also provides the user with an ergonomic soft “hourglass” geometry that allows a secure grip from any angle to assist with the installation and removal of the connector. The overmold geometry is shown in FIG. 4.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A connector for a cable comprising:
at least one conductor connected to a conductive contact;
a cylindrical metal shield at least partially surrounding the at least one conductor wherein the metal shield has a first slot and a second slot in the rear of the metal shield configured to engage a cable braid of the cable by having the braid be completely routed through the first and second slot.

2. The connector of claim 1 further comprising a relief cutout in the rear of the metal shield opposite the slot.

3. The connector of claim 1 further comprising overmolding placed on the outside of the connector.
